(19) United States
(12) Patent Application Publication
(10) Pub. No.: US 2011/0108191 A1
(43) Pub. Date: May 12, 2011

(54) ACTIVE ENERGY BEAM-CURABLE ADHESIVE COMPOSITION

(75) Inventors: Yasuyuki Sanai, Nagoya-shi (JP); Miki Tachibana, Nagoya-shi (JP); Mikihide Osoegawa, Nagoya-shi (JP)

(73) Assignee: TOAGOSEI CO., LTD., Minato-ku, Tokyo (JP)

(21) Appl. No.: 13/001,986

(22) PCT Filed: Jun. 29, 2009
(86) PCT No.: PCT/JP2009/061846

§ 371 Date: Dec. 29, 2010

(30) Foreign Application Priority Data
Jun. 30, 2008 (JP) 2008-171539

(51) Int. Cl. B32B 37/00; C08K 5/52

(52) U.S. Cl. 156/275.5; 524/140

(57) ABSTRACT

An object of the present invention is to provide an active energy beam-curable adhesive composition that has excellent adhesive power under any conditions of high temperature or high humidity, gives little coloration even when used for a long period of time, and gives no deposition of constituents in cold districts.

An active energy beam-curable adhesive composition that contains (A) a urethane (meth)acrylate having a polyester skeleton or a polycarbonate skeleton, (B) a phenol compound having one or more —C(CH₃)₂R groups (R denotes an alkyl group or a phenyl group) in a phenyl group, (C) a phosphite ester compound (provided that it is one having solubility in the composition), and (D) an ethylenically unsaturated group-containing compound other than component (A) above.

### TECHNICAL FIELD

The present invention relates to an active energy beam-curable adhesive composition that can carry out bonding of various types of substrates by irradiation with active energy beam such as an electron beam or UV rays, and the composition of the present invention is suitably used for laminate bonding of a thin layer adherend such as a plastic film or a plastic sheet used as an optical component and, furthermore, is suitably used in the production of various types of optical film or sheet used in a liquid crystal display device, an EL (electroluminescence) display device, a projection display device, an FED (field emission (field emission) display) display device, a plasma display device, etc., and is valued in these technical fields.

### BACKGROUND ART

Conventionally, as a lamination method in which thin layer adherends such as plastic films or sheets are laminated to each other or in which a thin layer adherend such as a plastic film or sheet and a thin layer adherend made of another material are laminated, a dry laminate method is mainly carried out in which, after a solvent type adhesive composition containing an ethylene-vinyl acetate copolymer or a polyurethane-based polymer is applied to a first thin layer adherend and dried, a second thin layer adherend is compression-bonded thereto by means of a nip roller, etc.

The adhesive composition used in this method generally contains a large amount of solvent in order to make the amount of composition applied uniform, and because of this a large amount of solvent vapor escapes during drying, thus causing problems in terms of toxicity, work safety, and environmental pollution.

As an adhesive composition that solves these problems, a solvent free adhesive composition has been examined.

As the solvent free adhesive composition, a two-part adhesive composition and an adhesive composition that is cured by active energy beam such as UV rays or an electron beam are widely used.

As the two-part adhesive composition, a so-called polyurethane-based adhesive composition is used, in which the main agent is a polymer mainly having a terminal hydroxyl group and the curing agent is a polyisocyanate compound having a terminal isocyanate group. However, this composition has the defect that the curing time is too long.

In contrast thereto, the active energy beam-curable adhesive composition has a high curing rate, therefore has excellent productivity, and has been attracting attention recently.

On the other hand, a thin display device such as a liquid crystal display device is widely used not only as a simple display device in a digital watch or in various types of electrical appliances but also as a display device of a television, a portable personal computer, a cellular telephone, a word processor, etc. In recent years, active energy beam-curable adhesives have been used for the lamination of various types of optical film used in the liquid crystal display device.

An adhesive composition used for the optical film is required to maintain its adhesive power under severe conditions of high temperature and high humidity. Although most conventional active energy beam-curable adhesive compositions have excellent adhesive strength in an initial stage, when they are used continuously for a long period of time under high temperature or high humidity, the adhesive strength thereof deteriorates, thus causing peeling off or whitening (opaque) due to moisture absorption.

The present inventors have previously proposed an adhesive with a composition comprising a polymer having a glass transition temperature of at least 40° C. (Patent Document 1), and have proposed an adhesive having excellent adhesion properties under high temperature and high humidity due to the use of an imide group-containing compound (Patent Document 2).

Furthermore, the present inventors have proposed an adhesive for use between a polymethyl methacrylate (PMMA) plate and a film (Patent Document 3).
(Patent Document 1) JP-A-2000-072833 (Claims) (JP-A denotes a Japanese unexamined patent application publication)
(Patent Document 2) JP-A-2001-064594 (Claims)
(Patent Document 3) JP-A-2005-272773 (Claims)

### DISCLOSURE OF INVENTION

### Problems to be Solved by the Invention

However, in recent years, there has been a demand for use under more severe conditions such as high temperature or high humidity, use outdoors under sunlight, and for a longer product life, and the conventionally proposed adhesive compositions are not satisfactory due to problems such as a decrease in the adhesive strength or coloration over time.

The present inventors have carried out an intensive investigation in order to find an active energy beam-curable adhesive composition having excellent adhesive power under high temperature and high humidity conditions and causing little coloration even when used for a long period of time.

Although as an active energy beam-curable adhesive, a composition comprising a urethane (meth)acrylate and a compound having a phosphite ester group and a phenolic hydroxy group in the molecule is known, in accordance with an examination by the present inventors, this cannot exhibit a coloration prevention effect over a long period of time (Patent Document 4).

As a result of an intensive investigation by the present inventors in order to find an active energy beam-curable adhesive composition having excellent adhesive power under any conditions of high temperature or high humidity and giving little coloration even when used for a long period of time, it has been found that a composition comprising a urethane (meth)acrylate having a specific structure, a phenol compound having a specific structure, and a sulfur-based antioxidant has excellent adhesive power under any conditions of high temperature or high humidity and gives little coloration (Patent Document 5).

However, the invention described in International Patent Application WO 2008-056751 is one that is excellent in terms of the above-mentioned performance but has a possibility of deposition of the sulfur-based antioxidant when stored in cold districts.

The present inventors have carried out an intensive investigation in order to find an active energy beam-curable adhesive composition that has excellent adhesive power under any conditions of high temperature or high humidity, gives little coloration even when used for a long period of time, and gives no deposition of constituents of the composition in cold districts.
(Patent Document 4) JP-A-2005-272495 (Claims)
(Patent Document 5) WO 2008-056751 (Claims)

As a result of various investigations by the present inventors, it has been found that a composition comprising a urethane (meth)acrylate having a specific structure, a phenol compound having a specific structure, and a specific phosphite ester-based antioxidant has excellent adhesive power under any conditions of high temperature or high humidity and gives little coloration, which is at a practical level, and the present invention shown in <1> below has thus been accomplished.

<1> An active energy beam-curable adhesive composition comprising (A) a urethane (meth)acrylate having a polyester skeleton or polycarbonate skeleton, (B) a phenol compound having one or more —C(CH₃)₂R groups (R denotes an alkyl group or a phenyl group) in a phenyl group but not having a phosphite ester group, (C) a phosphite ester compound (provided that it is one having solubility in the composition) not having one or more —C(CH₃)₂R groups (R denotes an alkyl group or a phenyl group) in a phenyl group, and (D) an ethylenically unsaturated group-containing compound other than component (A) above.

The present invention is explained in detail below.

In the present specification, acrylate and/or methacrylate are called (meth)acrylate, an acryloyl group and/or a methacryloyl group are called a (meth)acryloyl group, and acrylic acid and/or methacrylic acid are called (meth)acrylic acid.

The active energy beam-curable adhesive composition of the present invention comprises (A) a urethane (meth)acrylate having a polyester skeleton or polycarbonate skeleton (hereinafter, called component (A)), (B) a phenol compound having one or more —C(CH₃)₂R groups (R denotes an alkyl group or a phenyl group) in a phenyl group (hereinafter, called component (B)), (C) a phosphite ester compound (provided that it is one having solubility in the composition) (hereinafter, called component (C)), and (D) an ethylenically unsaturated group-containing compound (hereinafter, called component (D)) other than component (A) above.

Each of the components is explained below.

As components (A) to (D), each compound described below may be used on its own or in a combination of two or more types.

### 1. Component (A)

Component (A) is a urethane (meth)acrylate having a polyester skeleton or polycarbonate skeleton. In the present invention, since component (A) is contained, a cured material obtained has excellent adhesive power under each of the conditions of high temperature and high humidity.

On the other hand, a composition comprising a urethane (meth)acrylate having a skeleton other than a polyester skeleton or a polycarbonate skeleton, which is different from component (A), gives a cured material having degraded adhesive power under high temperature conditions and under high humidity conditions.

Component (A) may be either an oligomer or a polymer; one having a weight-average molecular weight of 500 to 50,000 is preferable, and it is more preferably 3,000 to 40,000.

The weight-average molecular weight referred to in the present invention is a molecular weight measured by gel permeation chromatography on a polystyrene basis.

As component (A), various types of compound may be used, and examples thereof include a compound obtained by reacting a hydroxyl group-containing (meth)acrylate with a reaction product between a polyol having a polyester or polycarbonate skeleton and an organic polyisocyanate.

Furthermore, component (A) is preferably a urethane (meth)acrylate having two (meth)acryloyl groups (hereinafter, also called a difunctional urethane (meth)acrylate), and is more preferably a difunctional urethane (meth)acrylate obtained by reacting a hydroxyl group-containing (meth)acrylate with a reaction product between a diol having a polyester or polycarbonate skeleton and an organic diisocyanate.

Examples of the polyol having a polyester skeleton include an esterification product of a diol such as a low molecular weight dial or a polycaprolactone diol with an acid component such as a dibasic acid or an anhydride thereof.

Examples of the low molecular weight diol include ethylene glycol, propylene glycol, cyclohexanedimethanol, 3-methyl-1,5-pentanediol, and 1,6-hexanediol.

Examples of the dibasic acid or an anhydride thereof include adipic acid, succinic acid, phthalic acid, tetrahydrophthalic acid, hexahydrophthalic acid, and terephthalic acid, and anhydrides thereof.

Examples of the polycarbonate polyol include a reaction product of the low molecular weight diol or/and a bisphenol such as bisphenol A with a dialkyl carbonate such as dibutyl carbonate or ethylene carbonate.

Examples of the organic polyisocyanate include tolylene diisocyanate, 1,6-hexane diisocyanate, 4,4′-diphenylmethane diisocyanate, polymethylene polyphenyl isocyanate, 1,6-hexane diisocyanate trimer, hydrogenated tolylene diisocyanate, hydrogenated 4,4′-diphenylmethane diisocyanate, xylylene diisocyanate, hydrogenated xylylene diisocyanate, paraphenylene diisocyanate, tolylene diisocyanate dimer, 1,5-naphthalene diisocyanate, hexamethylene diisocyanate adduct, 4,4′-dicyclohexylmethane diisocyanate, trimethylolpropane tris(tolylene diisocyanate) adduct, and isophorone diisocyanate. Furthermore, the organic polyisocyanate is preferably an organic diisocyanate.

Examples of the hydroxyl group-containing (meth)acrylate include hydroxyalkyl (meth)acrylates such as 2-hydroxyethyl (meth)acrylate, 2-hydroxypropyl (meth)acrylate, hydroxybutyl (meth)acrylate, hydroxypentyl (meth)acrylate, hydroxyhexyl (meth)acrylate, hydroxyoctyl (meth)acrylate, pentaerythritol tri-, di-, or mono-(meth)acrylate, and trimethylolpropane di- or mono-(meth)acrylate.

A method for synthesizing component (A) is not particularly limited, but it may be obtained by, for example, stirring and heating the organic isocyanate and polyol component used in the presence of an addition catalyst such as dibutyltin dilaurate so as to carry out an addition reaction, further adding a hydroxyalkyl (meth)acrylate, and stirring and heating so as to carry out an addition reaction.

As component (A), from the viewpoint of particularly excellent adhesive strength under high humidity and little coloration of the cured adhesive over time, a urethane acrylate employing a nonaromatic polyester polyol or a nonaromatic polycarbonate polyol, that is, a urethane (meth)acrylate having a nonaromatic polyester skeleton or a nonaromatic polycarbonate skeleton, is preferable.

### 2. Component (B)

Component (B) is a phenol compound having one or more —C(CH₃)₂R groups (R denotes an alkyl group or a phenyl group) in a phenyl group but not having a phosphite ester group. In the present invention, since component (B) is contained, coloration over time can be greatly suppressed. A phenol compound having one or more —C(CH₃)₂R groups in a phenyl group and further having a phosphite ester group cannot exhibit a coloration prevention effect for a long period of time as described above.

Examples of the alkyl group denoted by R include ones having 1 to 10 carbon atoms; an alkyl group having 1 to 4 carbon atoms is preferable, and a methyl group is more preferable.

The number of —C(CH₃)₂R groups in the phenyl group is preferably 1 or 2.

Component (B) preferably comprises a compound represented by Formula (1) below, and more preferably consists of one or more types of compounds represented by Formula (1).

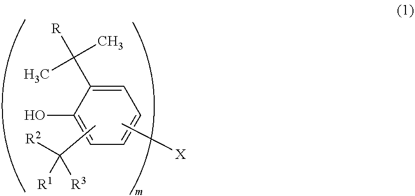

(In Formula (1), R denotes an alkyl group or a phenyl group, R¹ denotes a hydrogen atom, an alkyl group, or a phenyl group, R² and R³ denote a hydrogen atom or a methyl group, X denotes an m-valent group, and m denotes an integer of 1 to 4.)

In Formula (1), it is preferable that X is a monovalent or divalent group and m is an integer of 1 or 2.

It is also preferable that the alkyl group denoted by R¹ in Formula (1) is an alkyl group having 1 to 20 carbon atoms.

The compound of Formula (1) is preferably a compound represented by Formula (1)′ and/or Formula (1)″ below.

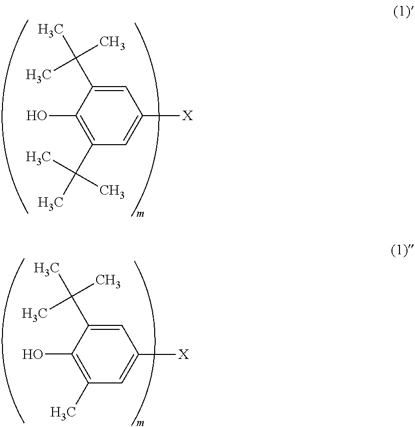

In Formula (1), specific examples of X include the following monovalent to tetravalent groups.

Examples of monovalent groups include an alkyl group, a group having one or more ester bonds (—COO— and/or —OCO—), a benzotriazoyl group, and a group containing a hindered amino skeleton.

As the alkyl group, an alkyl group having two or more carbon atoms is preferable in terms of coloration prevention of a cured material being excellent.

As the group having one or more ester bonds, an alkoxycarbonylalkyl group can be cited as an example, and a group represented by —R^{A}COOR^{B} is preferable. Here, R^{A} denotes an alkylene group having 1 to 12 carbon atoms, such as an ethylene group, and R^{B} denotes an alkyl group having 1 to 20 carbon atoms. R^{A} is preferably an alkylene group having 2 to 6 carbon atoms.

Examples of divalent groups include an alkylene group and a group having one or more ester bonds. As the group having one or more ester bonds, a divalent group having one or more ester bonds in which two or more structures selected from the group consisting of monovalent to tetravalent alkyl groups, an ester bond, and an ether bond are linked can be cited, and a divalent group having a spiro orthoether ring and one or more ester bonds is preferable.

Examples of trivalent groups include an isocyanurate group (1,3,5-triazine-2,4,6(1H, 3H, 5H)-trione-1,3,5-triyl group).

Examples of tetravalent groups include a group having one or more ester bonds, and preferred examples thereof include a tetravalent group having one or more ester bonds in which two or more structures selected from the group consisting of monovalent to tetravalent alkyl groups, an ester bond, and an ether bond are linked. More specific examples thereof include C(CH₂OCOR^{A}—)₄. R^{A} denotes an alkylene group having 1 to 12 carbon atoms as described above, and preferred examples are the same as above.

Furthermore, as a compound represented by Formula (1) above, (B1) a compound in which X is a group having one or more ester bonds (hereinafter, called component (B1)) is preferable.

In component (B1), preferred examples of a monophenol compound include a compound represented by Formula (2) below.

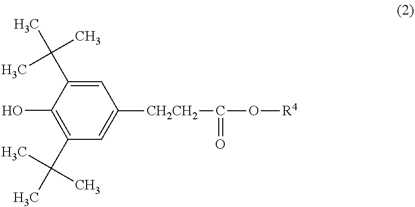

(Here, in Formula (2), R⁴ denotes an alkyl group having 1 to 20 carbon atoms.)

In Formula (2), when the number of carbon atoms of R⁴ is 1 or more, solubility in the composition is sufficient, and when the number of carbon atoms is no greater than 20, a desired effect can be obtained with a small amount thereof, and a uniform composition can be obtained.

As a specific example of the monophenol compound, a compound in which R⁴ is —C₁₈H₃₇ can be purchased from ADEKA Corporation under the product name AO-50 and is preferable due to ready availability.

Preferred examples of a diphenol compound for component (B1) include for example a compound represented by Formula (3) below.

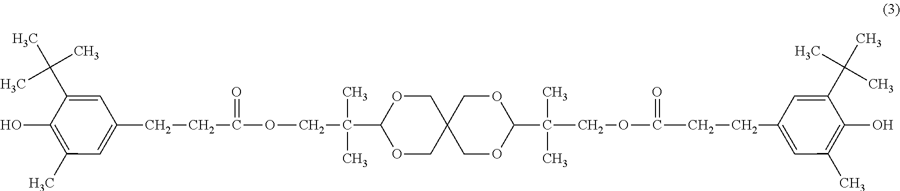

Other than the above-mentioned compounds, examples of component (B) include (B2) a compound, known as a UV absorber, having one or more —C(CH₃)₂R groups (R denotes an alkyl group or a phenyl group) in a phenyl group and further having a benzotriazole group (hereinafter, called component (B2)), and (B3) a compound, known as a light stabilizer, having one or more —C(CH₃)₂R groups (R denotes an alkyl group or a phenyl group) in a phenyl group and further having a hindered amino group (hereinafter, called component (B3)).

As component (B2), various type of compounds may be used as long as they are compounds having one or more —C(CH₃)₂R groups in a phenyl group and further having a benzotriazole group. These compounds are commercially available, and examples thereof include the TINUVIN series manufactured by Ciba Specialty Chemicals.

As component (B2), a compound represented by Formula (4) below is preferable.

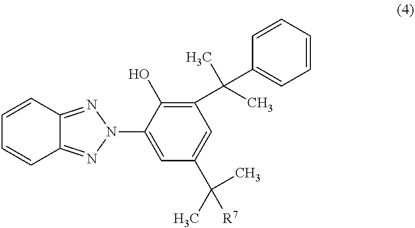

(Here, R⁷ denotes an alkyl group having 1 to 10 carbon atoms or a phenyl group.)

In Formula (4) above, those in which R⁷ is an alkyl group having 4 carbon atoms or a phenyl group are commercially available and may suitably be used.

As component (B3), various types of compounds may be used as long as they have one or more —C(CH₃)₂R groups in a phenyl group and further have a hindered amino group. These compounds are commercially available, and examples thereof include the TINUVIN series manufactured by Ciba Specialty Chemicals.

As component (B3), a compound represented by Formula (5) below is referable.

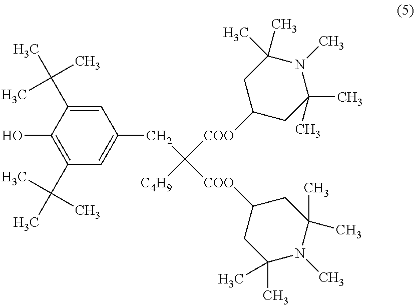

As component (B), any of components (B1) to (B3) above may be used.

As a preferred mode of application of component (B), it is preferable for it to comprise component (B1), which is essential, and further employ component (B2) and/or component (B3) in combination since coloration of a substrate can be suppressed when light passes through an adhesive layer and reaches the substrate.

### 3. Component (C)

Component (C) is a phosphite ester compound not having one or more —C(CH₃)₂R groups (R is an alkyl group or a phenyl group in a phenyl group), and it is necessary for it to have solubility in the composition. In the present invention, ‘having solubility’ means that, when 0.1 parts by weight of the phosphite ester compound is added to 100 parts by weight of the composition and this is allowed to stand at −10° C. for 7 days, there is no deposition observed visually.

‘One or more —C(CH₃)₂R groups (R is an alkyl group or a phenyl group) in a phenyl group’ means a group cited for component (B) above. A phosphite ester compound having one or more —C(CH₃)₂R groups in a phenyl group cannot exhibit a coloration prevention effect for a long period of time as described above.

In the present invention, due to component (C) being contained, an effect in suppressing coloration particularly when a laminate is exposed to light and heat at the same time is exhibited and, moreover, the problem of deposition even in cold districts can be eliminated.

As component (C), various types of compounds may be used.

Examples of component (C) include compounds represented by Formulae (6) to (8) below.

P(OR⁵)₃ (6)

(Here, in Formula (6), R⁵ denotes an alkyl group or an aromatic group. The plurality of R⁵s may be identical to or different from each other.)

(R⁶O)₂P—O—R⁷—O—P(OR⁶)₂ (7)

(Here, in Formula (7), R⁶ denotes an alkyl group and R⁷ denotes an aromatic ring-containing divalent group. The plurality of R⁶s may be identical to or different from each other.)

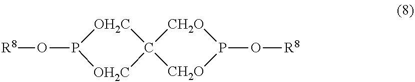

(Here, in Formula (8), R⁸ denotes an alkyl group or an aromatic group. The plurality of R⁸s may be identical to or different from each other.)

The alkyl group or aromatic group denoted by R⁵, R⁶, and R⁸ is a hydrocarbon group formed only from carbon and hydrogen atoms.

The alkyl group denoted by R⁵, R⁶, and R⁸ may be straight-chain or branched. One having 1 to 20 carbon atoms can be cited as an example, one having 6 to 14 carbon atoms is preferable since solubility in the composition is excellent, and one having 10 to 14 carbon atoms is more preferable.

Examples of the aromatic group denoted by R⁵ and R⁸ include a phenyl group and an alkyl-substituted phenyl group. The alkyl group of the alkyl-substituted phenyl group may be straight-chain or branched. One having 1 to 18 carbon atoms can be cited as an example, one having 6 to 15 carbon atoms is preferable since solubility in the composition is excellent, and one having 10 to 15 carbon atoms is more preferable.

Examples of the aromatic ring-containing divalent group denoted by R⁷ include the groups listed below.

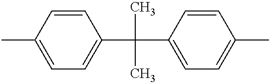

As component (C), compounds of Formula (6) and Formula (7) are preferred to a compound of Formula (8), which has a spirobicyclo orthoether skeleton, since solubility in the composition is excellent and a long-term coloration suppression effect is excellent. A compound of Formula (6) is more preferable since it has an excellent coloration suppression effect against heat or light from a small amount thereof added.

With regard to the compound of Formula (6), there are compounds represented by Formulae (6-1) to (6-4) below for cases in which R is an alkyl group (expressed as Rₐₗ) and cases in which R is an aromatic group (expressed as Rₐᵣ).

P(ORₐₗ)₃ (6-1)

RₐᵣOP(ORₐₗ)₂ (6-2)

(Rₐᵣ0)₂P(ORₐₗ) (6-3)

(RₐᵣO)₃P (6-4)

In Formulae (6-1) to (6-4), the plurality of Rₐₗs may be identical to or different from each other and the plurality of Rₐᵣs may be identical to or different from each other.

Furthermore, in Formulae (6-1) to (6-4), the plurality of Rₐₗs are preferably identical to each other and the plurality of Rₐᵣs are preferably identical to each other.

With regard to the compounds represented by (6-1) to (6-4) above, in terms of solubility in the composition and excellence of a long-term coloration suppression effect, they are preferred in the following order.

(6-2)>(6-1)>(6-3)>(6-4)

Among the compounds represented by Formulae (6-1) to (6-4), the compounds represented by Formulae (6-1) and (6-2) are more preferable.

Specific examples of the compounds represented by (6-1) to (6-4) above include the compounds below.

(6-1): trioctyl phosphite, tridecyl phosphite, triisodecyl phosphite, trilauryl phosphite
(6-2): a phenyl dialkyl phosphite (one having 8 to 12 carbon atoms as alkyl group)
(6-3): a diphenyl alkyl phosphite (one having 8 to 12 carbon atoms as alkyl group)
(6-4): triphenyl phosphite, tris(4-nonylphenyl) phosphite, tris(2,4-di-t-butyl) phosphite

### 4. Component (D)

The composition of the present invention comprises an ethylenically unsaturated group-containing compound for the purpose of adjusting the viscosity of the composition, target physical properties, etc.

As component (D), various types of compound may be used as long as they are ethylenically unsaturated group-containing compounds other than component (A). As component (D), there are a monomer, an oligomer, and a polymer.

### 4-1. Monomer

Examples of the monomer include a compound having one (meth)acryloyl group.

Examples of this compound include alkyl (meth)acrylates such as ethyl (meth)acrylate, propyl (meth)acrylate, butyl (meth)acrylate, pentyl (meth)acrylate, hexyl (meth)acrylate, heptyl (meth)acrylate, and 2-ethylhexyl (meth)acrylate; hydroxy group-containing (meth)acrylates such as hydroxyethyl (meth)acrylate and hydroxypropyl (meth)acrylate; aromatic group-containing (meth)acrylates such as benzyl (meth)acrylate, o-phenylphenylethyl (meth)acrylate, and p-cumylphenylethyl (meth)acrylate; and alicyclic (meth)acrylates such as isobornyl (meth)acrylate.

Other than (meth)acrylates, examples include (meth)acrylamide derivatives such as N-methylacrylamide, N-isopropylacrylamide, N,N-dimethylaminopropylacrylamide, N,N-dimethylacrylamide, and acryloylmorpholine; and N-vinyl compounds such as N-vinylformamide, N-vinyl-N-methylformamide, N-vinylacetamide, N-vinyl-N-methylacetamide, N-vinylpyrrolidone, and N-vinylcaprolactam.

Among them, a hydroxy group-containing (meth)acrylate is preferable since adhesion to a substrate can be improved. Furthermore, in terms of the refractive index of a cured material being excellent when the composition is applied to an optical member, etc., an aromatic group-containing (meth)acrylate is preferable, and a (meth)acrylate having two aromatic groups is preferable.

Examples of compounds having two or more (meth)acryloyl groups include alkylene glycol di(meth)acrylates such as ethylene glycol di(meth)acrylate, tetraethylene glycol di(meth)acrylate, propylene glycol di(meth)acrylate, and tripropylene glycol di(meth)acrylate; glycol di(meth)acrylates such as 1,6-hexanediol di(meth)acrylate and neopentyl glycol di(meth)acrylate; bisphenol di(meth)acrylates such as bisphenol A di(meth)acrylate or a derivative in which the aromatic nucleus is substituted with a halogen and bisphenol F di(meth)acrylate or a derivative in which the aromatic nucleus is substituted with a halogen; polyol poly(meth)acrylates such as dimethyloltricyclodecane di(meth)acrylate, trimethylolpropane tri(meth)acrylate, ditrimethylolpropane tetra(meth)acrylate, pentaerythritol tri(meth)acrylate, pentaerythritol tetra(meth)acrylate, and dipentaerythritol hexa(meth)acrylate; poly(meth)acrylates of alkylene oxide adducts of the above polyols; a di- or tri-(meth)acrylate of an isocyanuric acid alkylene oxide; and moreover, compounds described on pages 53 to 56 of ‘Saishin UV Koka Gijutsu’ (Latest UV Curing Technology) (Insatsu Joho Kyokai (Printing Information Society), 1991).

### 4-2. Oligomer

Examples of the oligomer include polyester (meth)acrylate, epoxy (meth)acrylate, and polyether (meth)acrylate.

### 4-2-1. Polyester (Meth)Acrylate Oligomer

Examples of the polyester (meth)acrylate oligomer include a dehydration condensation product of a polyester polyol with (meth)acrylic acid.

Examples of the polyester polyol include a reaction product of a polyol with a polycarboxylic acid or an anhydride thereof.

Examples of the polyol include low molecular weight polyols such as ethylene glycol, diethylene glycol, triethylene glycol, tetraethylene glycol, polyethylene glycol, propylene glycol, dipropylene glycol, tripropylene glycol, polypropylene glycol, butylene glycol, polybutylene glycol, tetramethylene glycol, hexamethylene glycol, neopentyl glycol, cyclohexanedimethanol, 3-methyl-1,5-pentanedial, 1,6-hexanediol, trimethylolpropane, glycerol, pentaerythritol, and dipentaerythritol, and alkylene oxide adducts thereof.

Examples of the polycarboxylic acid or an anhydride thereof include polybasic acids such as orthophthalic acid, isophthalic acid, terephthalic acid, adipic acid, succinic acid, fumaric acid, maleic acid, hexahydrophthalic acid, tetrahydrophthalic acid, and trimellitic acid, and anhydrides thereof.

As a polyester poly(meth)acrylate other than above, there can be cited compounds described in the above-mentioned ‘UV•EB Koka Zairyo’ (UV•EB Curing Materials) on pages 74 to 76.

### 4-2-2. Epoxy(Meth)Acrylate Oligomer

The epoxy(meth)acrylate is a compound obtained by an addition reaction of (meth)acrylic acid to an epoxy resin, and examples thereof include compounds described in the above-mentioned ‘UV•EB Koka Zairyo’ on pages 74 to 75.

Examples of the epoxy resin include an aromatic epoxy resin and an aliphatic epoxy resin.

Specific examples of the aromatic epoxy resin include resorcinol diglycidyl ether; a di- or poly-glycidyl ether of bisphenol A, bisphenol F, bisphenol S, bisphenol fluorene, or an alkylene oxide adduct thereof; a novolac epoxy resin such as a phenol novolac epoxy resin or a cresol novolac epoxy resin; glycidyl phthalimide; and o-phthalic acid diglycidyl ester.

Other than above, there can be cited compounds described in ‘Epokishi Jushi-Saishinnoshinpo-’ (Epoxy Resins-Latest Advances-) (Shokodo, 1990), Chapter 2 and ‘Kobunshi Kako’ (Polymer Processing), Supplement 9, Vol. 22, Special Edition, Epoxy Resins (Kobunshikankokai, 1973) on pages 4 to 6 and 9 to 16.

Specific examples of the aliphatic epoxy resin include the diglycidyl ether of an alkylene glycol such as ethylene glycol, propylene glycol, 1,4-butanediol, or 1,6-hexanediol; the diglycidyl ether of a polyalkylene glycol such as the diglycidyl ether of polyethylene glycol or polypropylene glycol; the diglycidyl ether of neopentyl glycol, dibromoneopentyl glycol, or an alkylene oxide adduct thereof; the polyglycidyl ether of a polyhydric alcohol such as the di- or tri-glycidyl ether of trimethylolethane, trimethylolpropane, glycerol, or an alkylene oxide adduct thereof, or the di-, tri-, or tetra-glycidyl ether of pentaerythritol or an alkylene oxide adduct thereof; the di- or poly-glycidyl ether of hydrogenated bisphenol A or an alkylene oxide adduct thereof; tetrahydrophthalic acid diglycidyl ether; and hydroquinone diglycidyl ether.

Other than above, there can be cited compounds described in the above ‘Kobunshi Kako’, Epoxy Resin Supplement, pages 3 to 6. Other than these aromatic and aliphatic epoxy resins, there can be cited an epoxy compound having a triazine nucleus in its skeleton, for example, TEPIC (Nissan Chemical Industries, Ltd.) and DENACOL EX-310 (Nagase ChemteX Corporation), and there also can be cited compounds described in the above ‘Kobunshi Kako’, Epoxy Resin Supplement, pages 289 to 296.

The alkylene oxide of the alkylene oxide adducts above is preferably ethylene oxide, propylene oxide, etc.

### 4-2-3. Polyether (Meth)Acrylate Oligomer

As the polyether (meth)acrylate oligomer, there is a polyalkylene glycol (meth)diacrylate, and examples thereof include polyethylene glycol di(meth)acrylate, polypropylene glycol di(meth)acrylate, and polytetramethylene glycol di(meth)acrylate.

### 4-3. Polymer

As the polymer, there are a (meth)acrylic polymer having a (meth)acryloyloxy group and one formed by introducing a (meth)acryloyl group into a side chain of a functional group-containing (meth)acrylic polymer, and examples thereof include compounds described in ‘UV•EB Koka Gijutsu’ above on pages 78 to 79.

### 5. Proportions

In the present invention, with regard to the proportions of components (A), (B), (C), and (D), when the total amount of components (A), (B), (C), and (D) is defined as 100 wt %, it is preferable that component (A) is 5 to 49 wt %, component (B) is 0.01 to 5 wt %, component (C) is 0.01 to 5 wt %, and component (D) is 50 to 94 wt %. It is more preferable that component (A) is 15 to 40 wt %, component (B) is 0.05 to 1 wt %, component (C) is 0.05 to 1 wt %, and component (D) is 50 to 84 wt %. When the proportion of component (A) is 5 wt % or greater, adhesive power under high temperature is excellent, and on the other hand when it is no greater than 50 wt %, the initial adhesive power and adhesive power under high humidity are excellent. When components (B) and (C) are each 0.01 wt % or greater, there is little coloration due to heat or light in a cured material formed by curing the composition, and when they are each no greater than 5 wt %, there is no deposition, the composition obtained is uniform, and curing properties are excellent. When component (D) is no greater than 94 wt %, the initial adhesive power and adhesive power under high temperature or high humidity are excellent.

Furthermore, in order to prevent poor appearance such as creasing or distortion of a substrate film that is to be laminated, the composition of the present invention preferably comprises, of the total amount of components (A) and (O), 2 to 30 wt % of methacrylate compound. Due to these methacrylate compounds being contained in the composition, the cure rate of the composition can be adjusted. When they are 2 wt % or greater, the adhesive strength becomes excellent, and when no greater than 30 wt %, curing properties and productivity are excellent.

The methacrylate compounds may be selected as appropriate from components (A) and (D) described above.

In applications where there is a requirement for little initial coloration, it is preferable that an aromatic group- and ethylenically unsaturated group-containing compound is at least 0 wt % but less than 50 wt % in the total amount of component (A) and component (D), it is more preferable that it is at least 0 wt % but less than 30 wt %, and it is most preferable that this compound is not contained.

On the other hand, in applications where a refractive index, etc. of a cured material is required, it is preferable that an aromatic group- and ethylenically unsaturated group-containing compound is at least 50 wt % but no greater than 80 wt % in the total amount of component (A) and component (D).

The aromatic group- and ethylenically unsaturated group-containing compound may be selected as appropriate from component (D).

### 5. Other Components

When the composition of the present invention is cured by UV rays, a photopolymerization initiator may be added as necessary.

Examples of the photopolymerization initiator include benzoin and alkyl ethers thereof such as benzoin, benzoin methyl ether, benzoin ethyl ether, and benzoin isopropyl ether; acetophenones such as acetophenone, 2,2-dimethoxy-2-phenylacetophenone, 2,2-diethoxy-2-phenylacetophenone, 1,1-dichloroacetophenone, 1-hydroxyacetophenone, 1-hydroxycyclohexyl phenyl ketone, and 2-methyl-1-[4-(methylthio)phenyl]-2-morpholinopropan-1-one; anthraquinones such as 2-methylanthraquinone, 2-ethylanthraquinone, 2-tertiary-butylanthraquinone, 1-chloroanthraquinone, and 2-amylanthraquinone; thioxanthene such as 2,4-dimethylthioxanthone, 2,4-diethylthioxanthone, 2-chlorothioxanthone, and 2,4-diisopylthioxanthone; ketals such as acetophenone dimethyl ketal and benzil dimethyl ketal; phosphine oxides such as 2,4,6-trimethylbenzoyldiphenylphosphine oxide; benzophenones such as benzophenone; and xanthones. These photopolymerization initiators may be used singly or in a combination with a benzoic acid-based, amine-based, etc. photopolymerization initiation accelerator.

The mixing proportion of the photopolymerization initiator is preferably at least 0.1 parts by weight but no greater than 10 parts by weight relative to 100 parts by weight of the composition, and more preferably at least 0.5 parts by weight but no greater than 5 parts by weight. From the viewpoint of there being little coloration over time, an α-hydroxyacetophenone-based or phosphine oxide-based photoinitiator is preferable.

Furthermore, the composition of the present invention may comprise a durability improving agent such as another antioxidant, a UV absorber other than component (B2), or a light stabilizer (HALS (hindered amine light stabilizer), etc.) other than component (B3), a leveling agent for making coating thickness uniform, or an antifoaming agent for suppressing foaming marks at an amount of 0 wt % to 5 wt % relative to 100 wt % of the total of components (A) to (D) and as necessary a photopolymerization initiator.

### 6. Production Process and Application Method

A process for producing the composition of the present invention is not particularly limited, and it is obtained by stirring or mixing the essential components of the present invention or the essential components and another component as necessary by a standard method.

The glass transition temperature (hereinafter, called Tg) of the cured composition is preferably at least 10° C. but no greater than 70° C. When the Tg is at least 10° C., sufficient adhesive strength is obtained during a heat resistance test, and when the Tg is no greater than 70° C., sufficient initial peel strength is obtained.

In the present invention, Tg means the temperature at which the main peak of the loss tangent (tan δ) of a viscoelastic spectrum of a cured material measured at 1 Hz is a maximum.

The composition of the present invention may be used for adhering various types of substrate, its application method may be a standard method, and examples thereof include a method in which after a substrate is coated, it is irradiated with active energy beam.

Examples of the active energy beam include UV rays, X rays, and an electron beam, and UV rays are preferable since inexpensive equipment may be employed. As the light source when curing is carried out with UV rays, various types may be used, and examples thereof include a pressurized or high pressure mercury lamp, a metal halide lamp, a xenon lamp, an electrodeless discharge lamp, and a carbon arc lamp. When curing is carried out with an electron beam, as an electron beam (EB) irradiator that can be used various types of equipment may be used, and examples thereof include a Cockcroft-Walton type, a Van de Graaff type, and a resonant transformer type. The electron beam preferably has an energy of 50 to 1,000 eV, and more preferably 100 to 300 eV.

The composition of the present invention may preferably be used in production of a laminate, and a standard method normally carried out in production of a laminate may be employed. For example, there is a method involving coating a first substrate with the composition, laminating a second substrate thereon, and then irradiating from the surface of either substrate with active energy beam. In this case, one that is transparent is used as at least one of the first substrate and the second substrate.

The composition of the present invention may preferably be used as an adhesive composition for an optical material and more preferably be used as an adhesive composition for optical film lamination.

In this case, a thin layer adherend used as an optical member is used as the substrate, and a laminate is obtained by the same method as above.

The thin layer adherend used as an optical member mainly employs a plastic film and is required to be transparent to active energy beam, the film thickness may be selected according to the thin layer adherend used and the intended purpose, and the thickness is preferably at least 0.1 μm but no greater than 1 mm.

Examples of the plastic of a plastic film include a polyvinyl chloride resin, a polyvinylidene chloride, a cellulose-based resin, polyethylene, polypropylene, polystyrene, an acrylonitrile-butadiene-styrene resin (ABS resin), polyamide, polyester, polycarbonate, polyurethane, polyvinyl alcohol, an ethylene-vinyl acetate copolymer, and a chlorinated polypropylene. According to the intended application, the surface may be subjected to a treatment such as metal vapor deposition.

A method for coating a thin layer adherend may be any conventional method, and examples thereof include methods involving a natural coater, a knife belt coater, a floating knife, a knife over roll, a knife on blanket, spray, dip, a kiss roll, a squeeze roll, a reverse roll, an air blade, a curtain flow coater, and a gravure coater.

Furthermore, the coating thickness of the composition of the present invention may be selected according to the thin layer adherend used and the intended purpose, and is preferably 0.1 to 1,000 μm, and more preferably 1 to 50 μm.

Since a laminate film or sheet obtained from the adhesive composition of the present invention has excellent adhesive power under high temperature condition and under high humidity condition, it can suitably be used for an optical film or sheet such as a polarizing film, a retardation film, a prism sheet, a luminance improving film, a light guide plate, or a diffusing plate used in a liquid crystal display device, etc.

The composition of the present invention is suitable for production of a retardation film-equipped polarizing plate.

Specifically, a polarizing film or a retardation film is coated with the composition, the coated polarizing film or retardation film is laminated with a retardation film or polarizing film, and active energy beam is applied from the surface of either of the substrates.

With regard to the polarizing film, various types thereof may be used as long as they have the function of selectively transmitting a certain unidirectional linearly polarized light from natural light.

Specific examples of the polarizing film include an iodine-based polarizing film formed by adsorbing and orienting iodine on a polyvinyl alcohol-based film, a dye-based polarizing film formed by adsorbing and orienting a dichroic dye on a polyvinyl alcohol-based film, and a coated polarizer formed by coating with a colorant in a (lyotropic) liquid crystal state, and orienting and immobilizing it.

The iodine-based polarizing film, the dye-based polarizing film, and the coated polarizer have the function of selectively transmitting a certain unidirectional linearly polarized light from natural light and absorbing other unidirectional linearly polarized light, and are called absorption type polarizers.

With regard to the iodine-based polarizing film and the dye-based polarizing film, one provided with a protective layer on one side or both sides thereof may usually be used.

With regard to a polarizing plate provided with a protective layer only on one side, a side that is adhered to a retardation film may be the side with the protective layer or the side without the protective layer.

Examples of the protective layer include those in which a cellulose acetate resin film such as triacetylcellulose or diacetylcellulose, an acrylic resin film, a polyester resin film, a polyarylate resin film, a polyether sulfone resin film, a cyclic polyolefin resin film employing a cyclic olefin such as norbornene as a monomer, etc. is laminated.

The protective layer is not limited to a film form. For example, a protective layer may be formed by coating.

The polarizing film used in the present invention is not limited to the above-mentioned absorption type polarizing films and may be one called a reflection type polarizer or a scattering type polarizer having the function of selectively transmitting a certain unidirectional linearly polarized light from natural light and reflecting or scattering other unidirectional linearly polarized light. The polarizer is not necessarily limited to those specifically cited above, and one having the function of selectively transmitting a certain unidirectional linearly polarized light from natural light may be used.

Among these polarizing films, it is preferable to use an absorption type polarizing plate, which has excellent visibility, and among them it is most preferable to use an iodine-based polarizing plate, which has a degree of polarization and a transmittance that are excellent.

As the retardation film, various types may be used; examples thereof include an optical film subjected to processing such as monoaxial or biaxial stretching and an optical film formed by coating a substrate with a liquid crystal compound, etc., and orienting and immobilizing it, and the relative magnitude (index ellipsoid) of the three-dimensional refractive index is controlled according to application requirements. It is used mainly for compensation by coloration of a liquid crystal layer of a liquid crystal display or compensation for a change in phase difference due to viewing angle.

Specific examples of the retardation film include, as a material for an optical film subjected to processing such as stretching, a polyolefin such as polyethylene, polypropylene, or a cyclic polyolefin, polycarbonate, polyvinyl alcohol, polystyrene, polymethyl methacrylate, polyarylate, and polyamide.

The cyclic polyolefin above is a general term for a resin obtained from a cyclic olefin such as norbornene, tetracyclododecene, or a derivative thereof, and examples thereof include those described in JP-A-3-14882, JP-A-3-122137, etc.

Specific examples thereof include a cyclic olefin-derived ring-opened polymer, a cyclic olefin addition polymer, a random copolymer between a cyclic olefin and an α-olefin such as ethylene or propylene, and a graft-modified product obtained by modifying the above with an unsaturated carboxylic acid or a derivative thereof. Examples further include a hydrogenated product of the above. Examples of commercial products include Zeonex and Zeonor manufactured by Nippon Zeon Corporation, Arton manufactured by JSR Corporation, and Topas manufactured by TICONA.

Furthermore, as an optical film formed by coating a substrate with a liquid crystal compound, etc., and orienting and immobilizing it, “WV film” (Fujifilm Corporation), “LC film” and “NH film” (both from Nippon Oil Corporation), etc. can be cited.

In accordance with the active energy beam-curable adhesive composition of the present invention excellent adhesive power can be maintained under any conditions of high temperature or high humidity, there is little coloration over time, and this is sustained for a long period of time. Moreover, no constituent of the composition is deposited in cold districts.

Therefore, the composition of the present invention is effective for bonding of a thin layer adherend such as a plastic film used as various types of optical members, and may be suitably applied to the production of an optical film used, in particular, in a liquid crystal display device, etc.

### EXAMPLES

The present invention is explained in detail below by reference to Examples and Comparative Examples. ‘Parts’ in each example below denotes wt %.

### Examples 1 to 7

Components (A) to (D) and the photopolymerization initiators shown in Table 1 below were dissolved by heating at 60° C. for 1 hour, thus giving active energy beam-curable adhesive compositions. Table 2 shows the proportion (wt %) of methacrylate in the total number of parts of components (A) and (D) in each composition (hereinafter, also called the ‘MA proportion’). Furthermore, the amount of each component used in Table 1 is given with the total amount of components (A) and (D) as 100 wt %.

The compositions thus obtained were evaluated in accordance with the test methods below. The results are given in Table 3.

TABLE 1

| | (A) | | (B) | | | | | (C) | |
|---|---|---|---|---|---|---|---|---|---|
| Ex. | M-1200¹⁾ | UN-9200²⁾ | AO-50³⁾ | AO-80⁴⁾ | TV900⁵⁾ | TV928⁶⁾ | TV144⁷⁾ | 135A⁸⁾ | 3010⁹⁾ |
| 1 | 30 | | | 0.5 | 1.0 | | | 0.1 | |
| 2 | 30 | | | 0.5 | 1.0 | | | | 0.1 |
| 3 | | 20 | 0.3 | | | | | 0.2 | |
| 4 | | 20 | | 0.2 | | 1.0 | | | 0.2 |
| 5 | 30 | | 0.3 | | | 1.0 | | | 0.2 |
| 6 | 30 | | 0.5 | | | | 0.3 | | 0.1 |
| 7 | 25 | | | 0.3 | | | | 0.1 | |

| | (D) | | | | Photoinitiator | |
|---|---|---|---|---|---|---|
| Ex. | IBX¹⁰⁾ | IBXA¹¹⁾ | HEMA¹²⁾ | OPPA¹³⁾ | Irg 184¹⁴⁾ | TPO¹⁵⁾ |
| 1 | | | 10 | 60 | 2 | 1 |
| 2 | | | 10 | 60 | 2 | 1 |
| 3 | 10 | | 15 | 55 | 2 | 1 |
| 4 | 10 | | 15 | 55 | 2 | 1 |
| 5 | 5 | | 10 | 55 | 2 | 1 |
| 6 | | | 10 | 60 | 2 | 1 |
| 7 | | 45 | 30 | | 2 | 1 |

In Table 1, the figures mean the number of parts, and the abbreviations have the following meanings.
¹⁾M-1200: urethane acrylate having nonaromatic polyester skeleton, weight-average molecular weight about 5,000 (ARONIX M-1200 manufactured by Toagosei Co., Ltd.)
²⁾UN-9200: urethane acrylate having nonaromatic polycarbonate skeleton, weight-average molecular weight about 20,000 (ART RESIN UN-9200A manufactured by Negami Chemical Industrial Co.)
³⁾AO-50: octadecyl 3-(3,5-di-t-butyl-4-hydroxyphenyl)propionate (AO-50 manufactured by ADEKA, compound of Formula (3) in which R¹ is an octadecyl group)
⁴⁾AO-80: 3,9-bis[2-{3-(3-t-butyl-4-hydroxy-5-methylphenyl)propionyloxy}-1,1-dimethylethyl]-2,4,8,10-tetraoxaspiro[5.5]undecane (AO-80 manufactured by ADEKA, compound of Formula (4))
⁵⁾TV900: 2-(2H-benzotriazol-2-yl)-4,6-bis(1-methyl-1-phenylethyl)phenol (TINUVIN 900 manufactured by Ciba Specialty Chemicals, compound of Formula (5) in which R⁴ is a phenyl group)
⁶⁾TV928: 2-(2H-benzotriazol-2-yl)-4-(1,1-dimethyl-3,3-dimethylbutyl)-6-(1-methyl-1-phenylethyl)phenol (TINUVIN928 manufactured by Ciba Specialty Chemicals, compound of Formula (5) in which R⁴ is a methyl group)
⁷⁾TV144: bis(1,2,2,6,6-pentaethyl-4-piperidyl)[3,5-bis(1,1-dimethyl)-4-hydroxyphenyl]butyl malonate (TINUVIN 144 manufactured by Ciba Specialty Chemicals, compound of Formula (6))
⁸⁾135A: diphenyl isodecyl phosphite (ADK STAB 135A manufactured by ADEKA Corporation)
⁹⁾3010: triisodecyl phosphite (ADK STAB 3010 manufactured by ADEKA Corporation)
¹⁰⁾IBX: isobornyl methacrylate (LIGHT-ESTER IB-X manufactured by Kyoeisha Chemical Co., Ltd.)
¹¹⁾IBXA: isobornyl acrylate (LIGHT-ACRYLATE IB-XA manufactured by Kyoeisha Chemical Co., Ltd.)
¹²⁾HEMA: hydroxyethyl methacrylate (LIGHT-ESTER HO manufactured by Kyoeisha Chemical Co., Ltd.)
¹³⁾OPPA: ortho-phenylphenol acrylate (ARONIX TO-2344 manufactured by Toagosei Co., Ltd.)
¹⁴⁾Irg184: 1-hydroxycyclohexyl phenyl ketone (IRGACURE 184 manufactured by Ciba Specialty Chemicals)
¹⁵⁾TPO: 2,4,6-trimethylbenzoyldiphenylphosphine oxide (LUCIRIN TPO manufactured by BASF)

TABLE 2

| Ex. | MA proportion | Low temperature stability |
|---|---|---|
| 1 | 10 | Good |
| 2 | 10 | Good |
| 3 | 25 | Good |
| 4 | 25 | Good |
| 5 | 15 | Good |
| 6 | 10 | Good |
| 7 | 30 | Good |

### Test Methods

### (1) Low Temperature Stability

The composition was allowed to stand in a refrigerator at −10° C. for 7 days, the presence/absence of deposition was examined visually, and evaluation was made using the following criteria.

Good: no deposition after 7 days. Fair: deposition was observed after 7 days.
Poor: deposition was observed after 1 to 2 days. Very poor: deposition was observed immediately after forming the composition.

### (2) Production of Sample

A 75 μm thick triacetylcellulose (hereinafter, abbreviated to TAC) film was coated using a wire bar coater with a composition thus obtained to give a coating thickness of 10 μm. A 75 μm thick TAC film was laminated thereon by means of a nip roller, and this was sent past a 120 W/cm focused metal halide lamp twice at a position 10 cm beneath the lamp at a conveyor speed of 5 m/min, thus bonding the films and giving a laminate film. This was called sample A. A laminate film was produced in the same manner as above except that the TAC film was changed to a 50 μm thick polyethylene terephthalate (hereinafter, abbreviated to PET) film and the coating thickness was changed to 50 μm. This was called sample B. Sample A thus obtained was allowed to stand under the following conditions and then subjected to an evaluation of peel strength.

Initial state: allowed to stand at room temperature for 30 minutes
After high temperature test: at 90° C. for 500 hours
After high humidity test: at 70° C. and 95% RH for 500 hours

Sample B thus obtained was allowed to stand under the following conditions and then subjected to an evaluation of coloration.

After high temperature test: at 120° C. for 1000 hours

After high humidity test: at 70° C. and 95% RH for 500 hours

Heat resistance/lightfastness cycle test: a process involving exposing a laminate film to UV at 250 J/cm² (UV-A) using a high pressure mercury lamp and heating it at 120° C. for 100 hours was repeated, and the test was continued until the heating time became 1000 hours.

### (3) Peel Strength

The peel strength of a sample that had been subjected to the high temperature test and the high humidity test under the above-mentioned conditions was measured using a tensile tester under the conditions below.

Test piece: 25 mm×100 mm
Peel angle: 180 degrees
Peel speed: 200 mm/min

When the adhesive strength was sufficiently high and the substrate broke during measurement of the peel strength, it was described as base material failure.

The measurement unit for the peel strength, gf/inch, is defined as 1 (gf/inch)=3.86×10⁻³ (N/cm).

### (4) Measurement of Coloration

The YI value of sample B prior to testing and YI values of sample B after the high temperature test, the high humidity test, and the heat resistance/lightfastness cycle test were measured using an integrating sphere type spectral transmittance meter (DOT-3C, manufactured by Murakami Color Research Laboratory). In the table below, for the coloration after each test, ΔYI (difference between YI value of sample B before the test and YI value of sample B after the test) is shown.

TABLE 3

| | Peel strength | | | Coloration | | | |
|---|---|---|---|---|---|---|---|
| | (gf/inch) | | | | | | After heat |
| | | After | | | | | resistance/ |
| | | high | | | After high | After high | lightfastness |
| | | temperature | After high | | temperature | humidity test | cycle test |
| Ex. | Initial | test | humidity test | Initial (YI) | test (ΔYI) | (ΔYI) | (ΔYI) |
| 1 | 890 | 920 | 740 | 1.3 | 2.2 | 0.7 | 2.4 |
| 2 | 890 | 920 | 730 | 1.4 | 2.7 | 0.8 | 3 |
| 3 | 990 | 920 | 890 | 1.6 | 3.1 | 0.8 | 3.2 |
| 4 | 890 | 810 | 780 | 1.6 | 3.1 | 1 | 3.1 |
| 5 | 820 | 800 | 760 | 1.3 | 3 | 1 | 3 |
| 6 | 890 | 900 | 750 | 1.4 | 2.5 | 0.7 | 3.4 |
| 7 | 930 | 940 | 900 | 0.9 | 2.3 | 0.3 | 2.5 |

### Comparative Examples 1 to 7

Active energy beam-curable adhesive compositions were produced in the same manner as in the Examples except that the components shown in Table 4 below were used. Table 5 shows the MA proportion of each composition.

The compositions thus obtained were subjected to the same evaluation as in Example 1. The results are given in Table 6.

TABLE 4

| | (A) | (A)′ | (B) | | | | (C) | (C)′ | (C)′ | (D) | | | | Photoinitiator | |
|---|---|---|---|---|---|---|---|---|---|---|---|---|---|---|---|
| Comp. Ex. | M-1200 | M-1600¹⁶⁾ | AO-50 | AO-80 | TV900 | TV928 | 135A | AO-412¹⁷⁾ | GP¹⁸⁾ | IBX | IBXA | HEMA | OPPA | Irg 184 | TPO |
| 1 | 30 | | | | | | | | | | | 10 | 60 | 2 | 1 |
| 2 | 30 | | | 0.3 | | | | | | | | 10 | 60 | 2 | 1 |
| 3 | 30 | | | 0.5 | 1.0 | | | 0.1 | | | | 10 | 60 | 2 | 1 |
| 4 | | 20 | | | | | | | | 10 | | 15 | 55 | 2 | 1 |
| 5 | | 20 | | 0.2 | | 1.0 | 0.2 | | | 10 | | 15 | 55 | 2 | 1 |
| 6 | 30 | | | 0.5 | 1.0 | | | | 0.3 | | | 10 | 60 | 2 | 1 |
| 7 | 25 | | | | | | | | | | 75 | | | 2 | 1 |

In Table 4, the figures mean the number of parts, and the abbreviations have the same meanings as in Table I apart from the following.
¹⁶⁾M-1600: polyether-based urethane acrylate, weight-average molecular weight about 3,000 (ARONIX M-1600 manufactured by Toagosei Co., Ltd.)
¹⁷⁾AO-412S: pentaerythritol tetrakis(β-laurylthiopropionate) (AO-412S manufactured by ADEKA Corporation)
¹⁸⁾6-[3-(3-t-butyl-4-hydroxy-5-methylphenyl)propoxy]-2,4,8,10-tetra-t-butyldibenzo[d,f][1,3,2]-dioxaphosphepine (SUMILIZER GP manufactured by Sumitomo Chemical Co., Ltd.)

TABLE 5

| Comp. Ex. | MA proportion | Low temperature stability |
|---|---|---|
| 1 | 10 | Good |
| 2 | 10 | Good |
| 3 | 10 | Poor |
| 4 | 25 | Good |
| 5 | 25 | Good |
| 6 | 10 | Good |
| 7 | 0 | Good |

TABLE 6

| | Peel strength | | | Coloration | | | |
|---|---|---|---|---|---|---|---|
| | (gf/inch) | | | | | | After heat |
| | | After | | | | | resistance/ |
| | | high | | | After high | After high | lightfastness |
| Comp. | | temperature | After high | | temperature | humidity test | cycle test |
| Ex. | Initial | test | humidity test | Initial (YI) | test (ΔYI) | (ΔYI) | (ΔYI) |
| 1 | 880 | 920 | 740 | 1.8 | 3.3 | 1.5 | 3.5 |
| 2 | 870 | 880 | 720 | 1.6 | 3.8 | 1.1 | 4.0 |
| 3 | 890 | 920 | 740 | 1.9 | 2.2 | 0.8 | 2.3 |
| 4 | 230 | 150 | 10 | 1.8 | 5.7 | 2.5 | 5.1 |
| 5 | 220 | 150 | 10 | 1.4 | 3.7 | 1.5 | 3.6 |
| 6 | 890 | 910 | 740 | 1.4 | 2.4 | 0.8 | 4.0 |
| 7 | 220 | 190 | 10 | 2.1 | 7.8 | 3.8 | 8.4 |

As is clear from the Examples, in accordance with the present invention, the composition did not form a deposit even under low temperature conditions and could maintain excellent adhesive power under high temperature conditions and under high humidity conditions, an optical member obtained could suppress coloration due to heat, humidity, or light for a long period of time, and it can suitably be used in particular for the production of an optical film for a liquid crystal display device, etc.

On the other hand, as is clear from the Comparative Examples, the compositions not containing components (B) and (C) could not suppress coloration. Furthermore, the compositions not using component (A) (Comparative Examples 4 and 5) could not give sufficient adhesive power. The composition containing a sulfur-based compound instead of a phosphite ester (Comparative Example 3) could give sufficiently low coloration, but had the problem that deposition was observed after 2 days when stored at low temperature. The composition comprising a compound having a phosphite ester and a phenolic hydroxy group in the molecule (Comparative Example 6) exhibited sufficient humidity resistance, but could not give a sufficient coloration suppression effect when exposed to heat or light for a long period of time.

### INDUSTRIAL APPLICABILITY

The adhesive composition of the present invention can be used as an adhesive for various types of substrates, can in particular maintain excellent adhesive power under high temperature and high humidity conditions, gives little coloration over time, is effective for bonding of a thin layer adherend such as a plastic film used as various types of optical member, and can particularly suitably be used in the production of an optical film used in a liquid crystal display device, etc.

1. An active energy beam-curable adhesive composition comprising:
(A) a urethane (meth)acrylate having a polyester skeleton or a polycarbonate skeleton;
(B) a phenol compound having one or more —C(CH₃)₂R groups (R denotes an alkyl group or a phenyl group) in a phenyl group but not having a phosphite ester group;
(C) a phosphite ester compound (provided that it is one having solubility in the composition) not having one or more —C(CH₃)₂R groups (R denotes an alkyl group or a phenyl group) in a phenyl group; and
(D) an ethylenically unsaturated group-containing compound other than component (A) above.

2. The active energy beam-curable adhesive composition according to claim 1, wherein when the total amount of components (A), (B), (C), and (D) is 100 wt %, component (A) is contained at 5 to 49 wt %, component (B) at 0.01 to 5 wt %, component (C) at 0.01 to 5 wt %, and component (D) at 50 to 94 wt %.

3. The active energy beam-curable adhesive composition according to claim 1, wherein component (B) above comprises a compound represented by Formula (1) below, 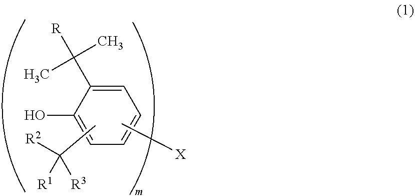
wherein R denotes an alkyl group or a phenyl group, R¹ denotesa hydrogen atom, an alkyl group, or a phenyl group, R² and R³ denote a hydrogen atom or a methyl group, X denotes an m-valent group, and m denotes an integer of 1 to 4.

4. The active energy beam-curable adhesive composition according to claim 3, wherein component (B) above comprises (B1) a compound in which X in Formula (1) above is a group having one or more ester bonds.

5. The active energy beam-curable adhesive composition according to claim 4, wherein (B1) above is a compound represented by Formula (3) below.

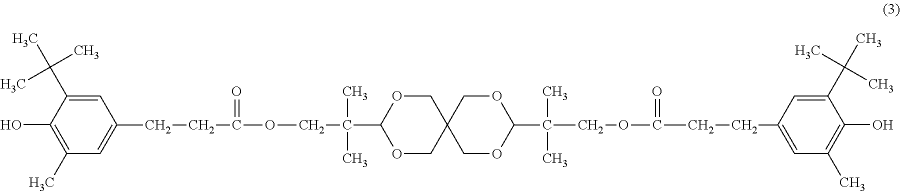

6. The active energy beam-curable adhesive composition according claim 4, wherein (B1) above is a compound represented by Formula (2) below, 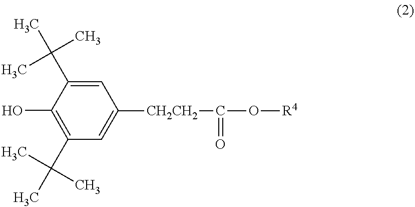
wherein R⁴ denotes an alkyl group having 1 to 20 carbon atoms.

7. The active energy beam-curable adhesive composition according to claim 4, wherein component (B) above comprises (B1) above, and (B2) a compound having one or more —C(CH₃)₂R groups (R denotes an alkyl group or a phenyl group) in a phenyl group and further having a benzotriazoyl group and/or (B3) a compound having at least a —C(CH₃)₂R group (R denotes an alkyl group or a phenyl group) in a phenyl group and further having a hindered amino group.

8. The active energy beam-curable adhesive composition according to claim 1, wherein component (C) above is a compound represented by any one of Formulae (6) to (8) below,
P(OR⁵)₃ (6)
wherein R⁵ denotes an alkyl group or an aromatic group and the plurality of R⁵s may be identical to or different from each other,
(R⁶O)₂P—O—R⁷—O—P(OR⁶)₂ (7)
wherein R⁶ denotes an alkyl group, R⁷ denotes a divalent group having an aromatic ring, and the plurality of R⁶s may be identical to or different from each other, 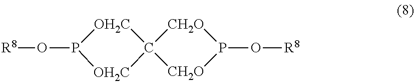
wherein R⁸ denotes an alkyl group or an aromatic group and the plurality of R⁸s may be identical to or different from each other.

9. The active energy beam-curable adhesive composition according to claim 1, wherein component (C) above is a compound represented by Formula (6) below,
P(OR⁵)₃ (6)
wherein, R⁵ denotes an alkyl group or an aromatic group and the plurality of R⁵s may be identical to or different from each other.

10. The active energy beam-curable adhesive composition according to claim 1, wherein component (C) above is a compound represented by Formulae (6-1) and/or (6-2) below,
P(ORₐₗ)₃ (6-1)
RₐᵣOP(ORₐₗ)₂ (6-2)
wherein Rₐₗ denotes an alkyl group, the plurality of Rₐₗs may be identical to or different from each other, the Rₐᵣs independently denote an aromatic group, and the plurality of Rₐᵣs may be identical to or different from each other.

11. The active energy beam-curable adhesive composition according to claim 1, wherein the composition further comprises a photopolymerization initiator.

12. The active energy beam-curable adhesive composition according to claim 1, wherein the composition comprises a methacrylate compound at 2 to 30 wt % in the total amount of component (A) and component (D).

13. An active energy beam-curable adhesive composition for optical film lamination, comprising the composition according to claim 1.

14. A process for producing a laminate, the process comprising:
a step of coating a first substrate with the composition according to claim 1;
a step of laminating a second substrate on the composition-coated first substrate; and
a step of irradiating from the surface of either substrate with active energy beam after the lamination of the second substrate.

15. The active energy beam-curable adhesive composition according to claim 1, wherein component (A) is a urethane (meth)acrylate having a polyester skeleton.

16. The active energy beam-curable adhesive composition according to claim 1, wherein component (D) comprises a hydroxy group-containing (meth)acrylate.

17. The active energy beam-curable adhesive composition according to claim 1, wherein component (D) comprises ortho-phenylphenol (meth)acrylate.

18. The active energy beam-curable adhesive composition according to claim 1, wherein when the total amount of components (A), (B), (C), and (D) is 100 wt %, a hydroxy group-containing (meth)acrylate and ortho-phenylphenol (meth)acrylate is contained at 50 to 94 wt %.
